(19) United States
(12) Patent Application Publication
(10) Pub. No.: US 2024/0366033 A1
(43) Pub. Date: Nov. 7, 2024

(54) SANDWICH CRIMPER

(71) Applicant: Crimpit Group Limited, London (GB)

(72) Inventors: Ian Peter Critchlow, London (GB); Michael Harper, London (GB)

(21) Appl. No.: 18/704,663

(22) PCT Filed: Oct. 25, 2022
(86) PCT No.: PCT/GB2022/052716

§ 371 Date: Apr. 25, 2024

(30) Foreign Application Priority Data
Oct. 27, 2021 (GB) 2115461.2

(51) Int. Cl. A47J 43/20; A21D 13/32

(52) U.S. Cl. CPC A47J 43/20; A21D 13/32

(57) ABSTRACT

A sandwich crimper for producing a sealed sandwich from two slices of bread comprises a crimper base 10 with a substantially flat lower surface 12 and a crimper lid (30, FIG. 2) with a substantially flat upper surface (32, FIG. 2). A bottom set of peripheral crimping teeth 14a is disposed along the outer edge of the crimper base 20 and a top set of peripheral crimping teeth (34a, FIG. 2) is disposed along the outer edge of the crimper lid (40, FIG. 2). The teeth in each set of crimping teeth (14b and 34b, FIG. 2) are formed from protruding trapezoidal prisms and the top and bottom sets of crimping teeth (14a and 34a, FIG. 2) are complementary to each other along every edge of the crimper base 20 and crimper lid 40. A peripheral retaining wall 18 is disposed along the outer edge of the bottom set of crimper teeth 14a for aligning the bread relative to the crimping teeth (14b and 34b, FIG. 2) and restraining the sandwich during the crimping process. See FIG. 1.

The present invention relates to a sandwich crimper and particularly but not exclusively to a sandwich crimper for producing a crimped sandwich for toasting in a toaster.

### BACKGROUND TO THE INVENTION

Standard methods for producing hot toasted snacks can be time consuming and, in many cases, result in a snack that is unhealthy.

For example, a toasted sandwich prepared in an oven or frying pan typically requires the slices of bread to be coated in a butter or an oil to ensure a desirable crispy outer layer that is golden brown and not burnt.

An alternative is to use an electric sandwich maker which presses the sandwich down into a sealed parcel and provides heat across the entire surface above and below the sandwich. While this is an effective solution to produce a hot toasted snack with less effort, electric sandwich makers have significant disadvantages. Electric sandwich makers are bulky, occupying valuable space on either a kitchen surface or in a kitchen cupboard, require an electrical outlet in a kitchen which may be in short supply and can be difficult to clean as excess sandwich filling may leak onto the electric sandwich maker and is often baked onto the surface. Additionally, electric sandwich makers take a significant amount of time to cool to room temperature. Before an electric sandwich maker cools, there is an exposed hot surface which may present a danger when left on a kitchen surface. The electric sandwich maker must cool before it can be cleaned.

A further alternative is to toast a sandwich in a toaster, using a toaster bag, also known as a “Toastabag”. A toaster bag is a rectangular, heat resistant bag in which a sandwich is inserted before inserting the toaster bag into a toaster. The toaster bag does not prevent the sandwich contents from leaking out of the sandwich during toasting, has a limited number of uses, and requires cleaning after use. A toaster bag is difficult to clean thoroughly due the spilled sandwich contents typically congregating in the corners of the bag.

A sandwich may be toasted in a toaster without a toaster bag if the edges were sealed. Sandwich sealing devices are available. Unfortunately, sealed sandwiches made from these devices often provide a sealed sandwich with weak seals at the edges of the sandwich, with top and bottom faces convex in shape and a thickness greater than that of a toaster slot. These traits prevent a sealed sandwich from being toasted in a traditional toaster. Poorly sealed edges can result in the filling of the sandwich leaking into the toaster, which may be difficult to clean or cause damage to the toaster. If the top and bottom faces of the sandwich are convex in shape, hotspots will occur during toasting in a traditional toaster as central portions of each face will be closer to the heating elements in the toaster. This results in a toasted sandwich that is either burnt in the centre of each face, or not crispy at the edges. Finally, a sealed sandwich may simply be too thick to fit inside a toaster slot.

It is an object of the present invention to reduce or substantially obviate the aforementioned problems.

### STATEMENT OF INVENTION

According to the first aspect of the invention there is provided a sandwich crimper for producing a sealed sandwich from two slices of bread comprising:
a crimper base with a substantially flat lower surface;
a crimper lid with a substantially flat upper surface;
a bottom set of peripheral crimping teeth disposed along the outer edge of the crimper base;
a top set of peripheral crimping teeth disposed along the outer edge of the crimper lid;
teeth in each set of crimping teeth that are formed from protruding trapezoidal prisms and in which the top and bottom sets of crimping teeth are complementary to each other along every edge of the crimper base and crimper lid; and
a peripheral retaining wall disposed along the outer edge of the bottom set of crimper teeth for aligning the bread relative to the crimping teeth and restraining the sandwich during the crimping process;

The sealed sandwich may possess a top and bottom face which is substantially flat, allowing the sealed sandwich to be toasted in a toaster without the formation of hot spots due to varying distances between portions of the bread and the heating elements of the toaster. By preventing hotspots, the entirety of each face of the sandwich is more likely to toast at a uniform rate. This reduces the chance that the centre of each face will burn as the edges toast.

The flat nature of the lower surface of the crimper base and upper surface of the crimper lid allow the sandwich crimper to crimp the edges of the sandwich without producing a sealed sandwich with a substantially convex shape.

The trapezoidal shape of the teeth has been found to provide a stronger crimp than wave-shaped teeth, reducing the risk of the crimp coming adrift. Additionally, heat is not required to produce a strong seal.

The total height between the internal surfaces of the flat lower surface and flat upper surface when the crimper base and crimper lid are pressed together, may not be greater than 24 mm. This produces a sealed sandwich with a thickness of no greater than 24 mm, which allows the sandwich to be inserted into a traditional toaster. Optionally, the total height between these internal surfaces may be less than 24 mm, e.g. between 20-24 mm, to produce a thinner sandwich.

The complementary crimping teeth may feature a continuous gap of 1-2 mm, preferably 1-1.5 mm, between each set of crimping teeth when fully engaged. This continuous gap ensures there is no tearing of the bread during the crimping process, allowing for the production of a sealed sandwich which is undamaged.

The crimper base may feature a base wall disposed below the bottom set of crimping teeth protruding into the centre of the crimper base from the outer edge. This allows the contents of the sandwich to be contained away from the crimping edge during crimping. The base wall may feature a slope to channel the contents away from the crimping teeth during crimping.

The crimping teeth may protrude from the lower surface of the crimper base or the base wall by 5-15 mm. The base of each tooth may have a width of 10-30 mm and the opposite, parallel side may have a width of 5-20 mm.

The edges of the crimper base and crimper lid may be straight. The sandwich crimper may have a length of 10-25 cm, preferably a length of 15-20 cm. The sandwich crimper may have a width of 10-25 cm, preferably a width of 15-20 cm. The sandwich crimper may be substantially square in shape to produce a sealed sandwich substantially square in shape. As sliced bread typically is square in shape, the square shape of the sandwich crimper reduces wastage from excess bread not contained within the retaining wall.

The crimper may have rounded corners to produce a sealed sandwich with rounded corners, preventing the formation of square corners with weaker seals.

The crimping teeth may be identical in size and shape. Where rounded corners in the crimper base and crimper lid are provided, a crimping tooth may be disposed in each rounded corner of the crimper base with a complementary gap in the top set of crimping teeth in the crimper lid.

The top and bottom sets of crimping teeth may be complementary in shape in a plurality of orientations so that there is no need for alignment pointers.

The crimper base may be provided with a second lid forming a sealed container for storing the sealed sandwich in the crimper base after crimping.

The second lid may be made from silicon.

According to the second aspect of the invention there is provided a method for sealing a sandwich comprising the steps:
providing a sandwich crimper according to the first aspect of the invention;
inserting a first slice of bread into the crimper base, retained within the retaining wall;
inserting the sandwich contents into the crimper base on top of the first slice of bread;
inserting a second slice of bread into the crimper base, aligned with the first slice of bread;
placing the crimper lid over the crimper base; and
applying pressure to the crimper lid, engaging the top and bottom sets of crimping teeth and crimping the edges of the sandwich.

The first slice of bread and second slice of bread may be sandwich thins also known as thins. Sandwich thins are typically made from soft bread. Sandwich thins have a thickness of 6-9 mm or half the thickness of a standard slice of bread. Sandwich thins are manufactured from a flat sheet of dough. The flat sheet of dough may have a thickness of approximately 0.5-1.5 cm. Individual square portions are typically cut from the sheet of flat dough. The square portions may have rounded edges. Each side of the square portion has a length of 8-12 cm. The square portions of flat dough are baked. The baked square portions are sliced through the centre to produce two sliced portions. Each sliced portion forms one sandwich thin. The sandwich contents are contained between each sandwich thin.

Where a base wall is provided the sandwich contents may be inserted within the base wall, ensuring the sandwich contents are separated from the crimping edge. The sandwich contents may include one or more of cheese, meat, fish, fruit, vegetables, spreads, and sauces or any combination thereof.

Using the sandwich crimper with this method does not require heat to produce a strong seal. Where the first slice of bread and second slice of bread are sandwich thins, a sealed sandwich is produced without the removal of any bread or decrusting, avoiding wastage. Once the sandwich has been sealed, it may be inserted into a toaster to produce a toasted sealed sandwich. After crimping, the crimper lid may be replaced with the second lid when provided to store the sealed sandwich in a sealed container, for eating or toasting later.

### BRIEF DESCRIPTION OF THE DRAWINGS

For a better understanding of the present invention, and to show more clearly how it may be carried into effect, reference will now be made by way of example only to the accompanying drawings, in which:

FIG. 1 shows a perspective view of an embodiment of the crimper base according to the invention;

FIG. 2 shows a perspective view of a first crimper lid, which fits to the crimper base of FIG. 1.

FIG. 3 shows a circular embodiment in accordance with the present invention;

FIG. 4 shows the base of the embodiment of FIG. 3;

FIGS. 5 to 7 show the lid of the embodiment of FIG. 3; and

FIGS. 8a and 8b show a circular and square embodiment in accordance with the present invention having a circular aperture to facilitate removal of a sandwich.

### DESCRIPTION OF PREFERRED EMBODIMENTS

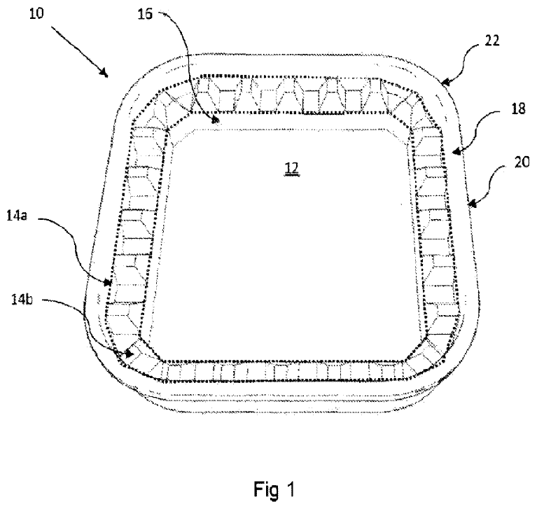

Referring firstly to FIG. 1, a crimper base is generally indicated at 10. The crimper base 10 has a flat lower surface 12. The crimper base 10 is square in shape. The crimper base 10 has rounded corners 22. Each edge of the crimper base 20 has a length of 12-18 cm.

In this embodiment, the size and shape of the sandwich crimper is tailored for sandwiches made from sandwich thins. However, the sandwich crimper can also be used with other breads.

The flat lower surface 12 is equipped with a bottom set of peripheral crimping teeth 14a disposed along every edge of the crimper base 20. The bottom set of peripheral crimping teeth 14a protrude from a base wall 16. The base wall 16 is raised from the flat lower surface 12. The bottom set of peripheral crimping teeth 14a consists of a plurality of identical lower crimping teeth 14b. In this embodiment, the bottom set of crimping teeth 14a, protrude from the base wall 16 by 8-12 mm. Each lower crimping tooth 14b in the bottom set of crimping teeth 14a has a base width of 8-12 mm. The side opposite and parallel to the base has a width of 4-6 mm. The lower crimping teeth 14b in the bottom set of crimping teeth 14a have a thickness of 8-12 mm. One lower crimping tooth 14b is disposed within each of the rounded corners 22 on the base wall 16. The lower crimping teeth 14b disposed in the rounded corners are positioned diagonally at an angle of 45° relative to the other lower crimping teeth 14b, for ensuring a round crimped edge of the sealed sandwich. This is to prevent a corner having a weaker seal.

The crimper base is further equipped with a peripheral retaining wall 18 disposed along the straight edges of the crimper base 20. The retaining wall 18 has a thickness of 0.8-1.2 cm. The retaining wall 18 aligns the bread relative to the bottom set of crimping teeth 14a and restrains the movement of the sandwich during crimping.

The base wall 16 has a height and thickness of 1-1.2 cm at its base. The base wall 16 has a thickness of 0.9-1.1 cm at the point at which the bottom set of crimping teeth 14a protrude. The variation in thickness from the top of the base wall 16 to the bottom of the base wall 16 is achieved through a slope in the base wall 16. The base wall 16 contains the contents of the sandwich wherein the sloped walls channel the contents of the sandwich away from the crimping edge.

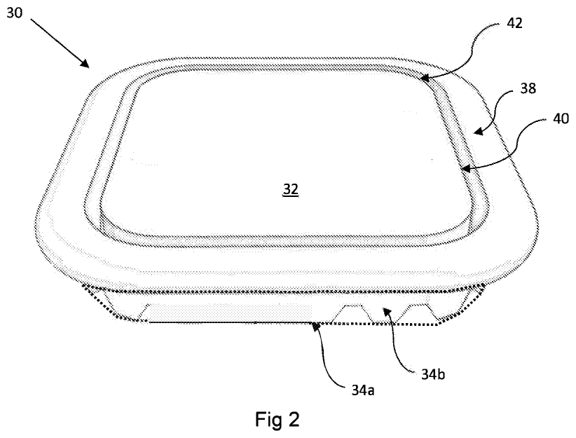

Referring now to FIG. 2, a crimper lid is generally indicated at 30. The crimper lid 30 has a flat upper surface 32. The crimper lid 30 is square in shape. The crimper lid 30 has rounded corners 42. Each edge of the crimper lid 40 has a length of 12-18 cm.

The flat upper surface 32 is equipped with a top set of peripheral crimping teeth 34a disposed along every edge of the crimper lid 40. The top set of peripheral crimping teeth 34a protrude from the flat upper surface 32. The top set of peripheral crimping teeth 34a consists of a plurality of identical upper crimping teeth 34b. The top set of peripheral crimping teeth 34a, protrude from the flat upper surface 32 by 8-12 mm. Each upper crimping tooth 34b has a base width of 8-12 mm. The side opposite and parallel to the base has a width of 4-6 mm. The upper crimping teeth 34b have a thickness of 8-12 mm. Two upper crimping teeth 34b are disposed either side of the rounded corners 42, leaving a gap disposed diagonally at an angle of 45° relative to the upper crimping teeth 14b disposed along the straight edges of the crimper lid 40. The structure of the top set of crimping teeth 34a is complementary to the bottom set of crimping teeth 14a. In this embodiment, the top set of crimping teeth 34a is complementary to the bottom set of crimping teeth 14a in a plurality of orientations.

The crimping lid is further equipped with a peripheral canopy 38. The peripheral canopy extends from the crimping lid by 0.5-1.5 cm for distributing pressure evenly during the crimping process.

When each set of crimping teeth 14a, 34a are fully engaged there is a continuous gap of 1-1.5 mm between each set. The continuous gap is achieved through contact between the peripheral retaining wall 18 and the peripheral canopy 38. This continuous gap prevents tearing of the bread during the crimping process, allowing for the production of a sealed sandwich which is undamaged.

Additionally, when each set of crimping teeth 14a, 34a are fully engaged, the total height between the internal surfaces of the flat lower surface 12 and flat upper surface 32 is 22-24 mm. This allows for the production of a sandwich with a thickness of no greater than 24 mm.

The sandwich crimper is used to seal a sandwich made from two thin slices of bread by inserting a first slice of bread into the crimper base 10 positioned within the retaining wall 18. The edges of the slice of bread are positioned above the bottom set of crimping teeth 14a. The sandwich contents are inserted on top of the first slice of bread. In this embodiment, the sandwich contents are retained within the base walls 16. A second slice of bread is inserted on top of the sandwich contents. The second slice is retained within the retaining wall 18, aligned above the first slice of bread. The crimper lid 30 is positioned over the sandwich. The top set of crimping teeth 34a is aligned with the bottom set of crimping teeth 14a in a plurality of orientations. Pressure is applied to the crimper lid to engage the crimping teeth and crimp the edges of the sandwich. The flat lower surface 12 and flat upper surface 32 produce a crimped sandwich with a substantially flat top and bottom face, suitable for toasting in a toaster.

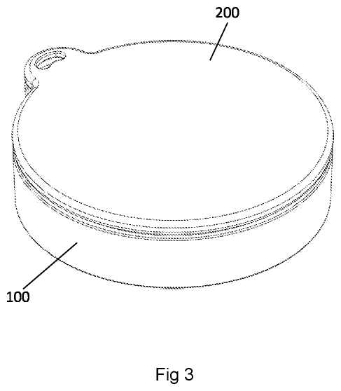

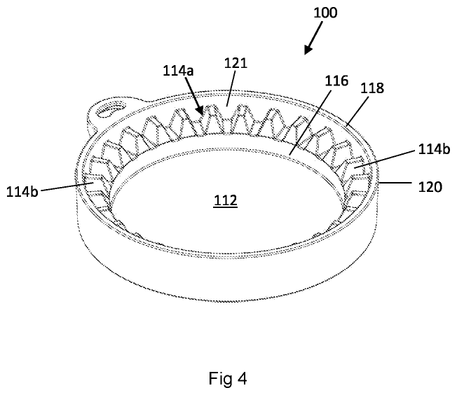

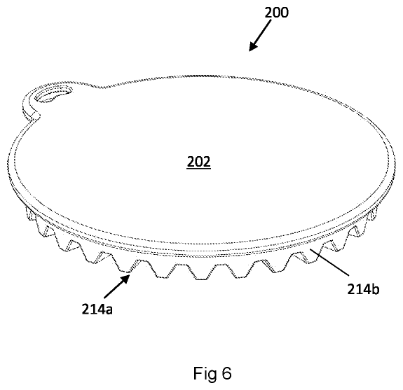

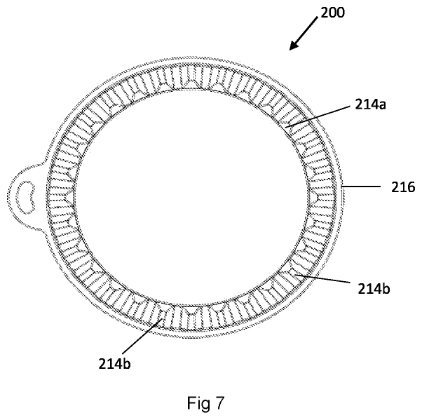

FIGS. 3 to 7 show an embodiment where the crimper base 100 and the crimper lid 200 is circular in shape.

The crimper base 100 has a flat lower surface 112. The crimper base 100 is circular in shape. The crimper base has a diameter of 9-18 cm, advantageously 10-12 cm.

In this embodiment, the size and shape of the sandwich crimper is tailored for sandwiches made from sandwich thins.

The flat lower surface 112 is equipped with a bottom set of peripheral crimping teeth 114a disposed along the edge 120 of the crimper base 100. The bottom set of peripheral crimping teeth 114a upwardly depend and protrude from a base wall 116. The base wall 116 is raised from the flat lower surface 112. The bottom set of peripheral crimping teeth 114a consists of a plurality of identical lower crimping teeth 114b. In this embodiment, the bottom set of crimping teeth 114a, protrude from the base wall 116 by 8-12 mm. Each lower crimping tooth 114b in the bottom set of crimping teeth 114a has a base width of 8-12 mm. The side opposite and parallel to the base has a width of 4-6 mm. The lower crimping teeth 114b in the bottom set of crimping teeth 114a have a thickness of 8-12 mm.

The crimper base 100 is further equipped with a peripheral retaining wall 118 disposed around the edge of the crimper base 120. The retaining wall 118 has a thickness of 0.8-1.2 cm. The retaining wall 118 aligns the bread relative to the bottom set of crimping teeth 114a and restrains the movement of the sandwich during crimping. The teeth 114b are arranged circumferentially around the inner face 121 of the retaining wall 118 of the base 100.

The base wall 116 has a height and thickness of 0.5-1.5 cm at its base. The base wall 116 has a thickness of 0.9-1.1 cm at the point at which the bottom set of crimping teeth 14a protrude. The variation in thickness from the top of the base wall 116 to the bottom of the base wall 116 is achieved through a slope in the base wall 116. The base wall 116 contains the contents of the sandwich wherein the sloped walls channel the contents of the sandwich away from the crimping edge.

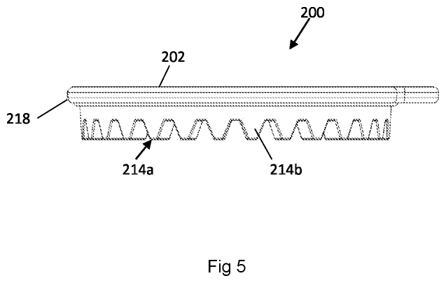

Referring now to FIGS. 5 to 7, a crimper lid 200 has a flat, planar upper surface 202. The crimper lid 200 is circular in shape. The crimper lid 200 has a diameter that corresponds to the base 100 being 9-18 cm, advantageously 10-12 cm.

The flat upper surface 202 is equipped with a top set of downwardly depending peripheral crimping teeth 214a circumferentially disposed around the edge of the crimper lid 216. The top set of peripheral crimping teeth 214a protrude from the flat upper surface 202. The top set of peripheral crimping teeth 214a consists of a plurality of identical upper crimping teeth 214b. The top set of peripheral crimping teeth 214a, protrude from the flat upper surface 202 by 8-12 mm. Each upper crimping tooth 214b has a base width of 4-12 mm. The side opposite and parallel to the base has a width of 2-6 mm. The upper crimping teeth 214b have a thickness of 8-12 mm. The structure of the top set of crimping teeth 214a is complementary to the bottom set of crimping teeth 114a. In this embodiment, the top set of crimping teeth 214a is complementary to the bottom set of crimping teeth 114a in a plurality of orientations.

The crimping lid is further equipped with a peripheral canopy 218. The peripheral canopy extends from the crimping lid by 0.5-1.5 cm for distributing pressure evenly during the crimping process.

When each set of crimping teeth 114a, 214a are fully engaged there is a continuous gap of 0.5-1.5 mm. The continuous gap is achieved through contact between the peripheral retaining wall 118 and the peripheral canopy 218. This continuous gap prevents tearing of the bread during the crimping process, allowing for the production of a sealed sandwich which is undamaged.

Additionally, when each set of crimping teeth 114a, 214a are fully engaged, the total height between the internal surfaces of the flat lower surface 112 and flat upper surface 202 is 22-24 mm. This allows for the production of a sandwich with a thickness of no greater than 24 mm.

The sandwich crimper is used to seal a sandwich made from two thin slices of bread by inserting a first slice of bread into the crimper base 100 positioned within the retaining wall 118. The edges of the slice of bread are positioned above the bottom set of crimping teeth 114a. The sandwich contents are inserted on top of the first slice of bread. In this embodiment, the sandwich contents are retained within the base walls 116. A second slice of bread is inserted on top of the sandwich contents. The second slice is retained within the retaining wall 118, aligned above the first slice of bread. The crimper lid 200 is positioned over the sandwich. The top set of crimping teeth 214a is aligned with the bottom set of crimping teeth 114a in a plurality of orientations. Pressure is applied to the crimper lid to engage the crimping teeth and crimp the edges of the sandwich. The flat lower surface 112 and flat upper surface 202 produce a crimped sandwich with a substantially flat top and bottom face, suitable for toasting in a toaster.

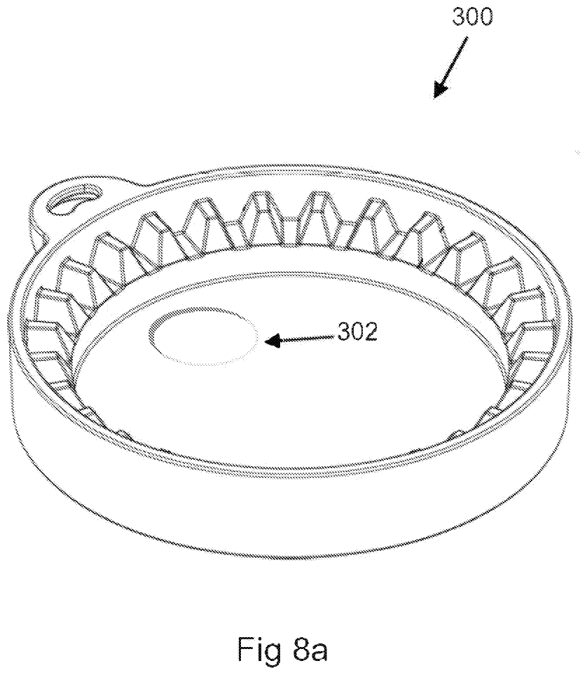

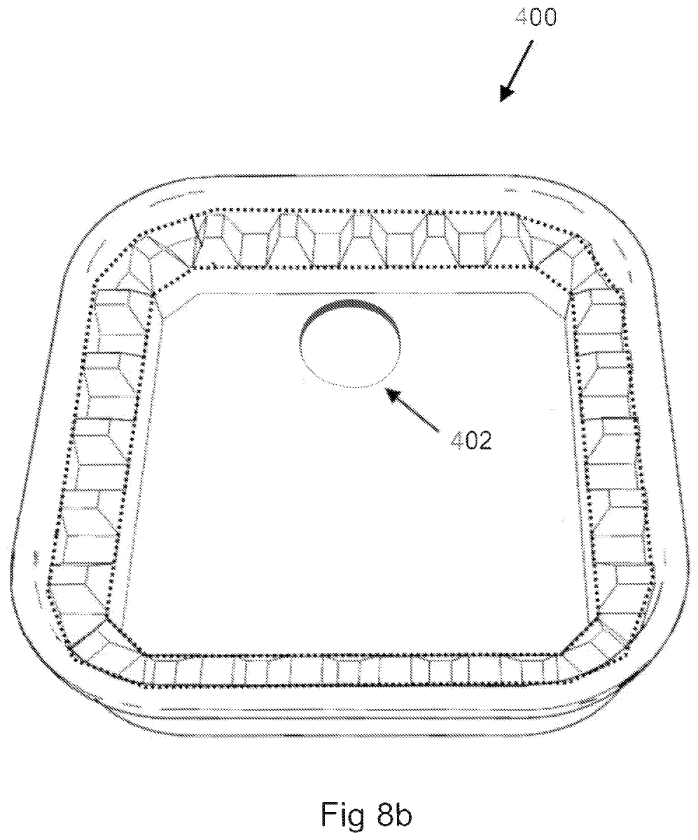

FIG. 8 shows an embodiment where the circular crimper base 300 has a circular aperture 302 in the base to facilitate the removal of the crimped sandwich. The aperture is of a sufficient diameter to enable a user to extend a finger therethrough to displace and remove a sandwich once crimped.

FIG. 8b shows an embodiment where the square crimper base 400 has a circular aperture 402 to facilitate the removal of a crimped sandwich in a manner similar to that described for FIG. 8a.

The embodiments described above are provided by way of example only, and various changes and modifications will be apparent to persons skilled in the art without departing from the scope of the present invention as defined by the appended claims.

1. A sandwich crimper for producing a sealed sandwich from two slices of bread comprising:
a crimper base with a substantially flat lower surface;
a crimper lid with a substantially flat upper surface;
a bottom set of peripheral crimping teeth disposed along the outer edge of the crimper base;
a top set of peripheral crimping teeth disposed along the outer edge of the crimper lid;
teeth in each set of crimping teeth that are formed from protruding trapezoidal prisms and in which the top and bottom sets of crimping teeth are complementary to each other along every edge of the crimper base and crimper lid; and
a peripheral retaining wall disposed along the outer edge of the bottom set of crimper teeth for aligning the bread relative to the crimping teeth and restraining the sandwich during the crimping process.

2. A sandwich crimper as claimed in claim 1, in which the total height between the internal surfaces of the flat lower surface and flat upper surface does not exceed 24 mm.

3. A sandwich crimper as claimed in claim 2, in which the total height between the internal surfaces of the flat lower surface and flat upper surface is 20-24 mm.

4. A sandwich crimper as claimed in claim 1, in which there is a 1-2 mm continuous gap between the top and bottom set of complementary crimping teeth when the crimper base and crimper lid are in contact for ensuring the crimped sandwich is undamaged during the crimp process;

5. A sandwich crimper as claimed in claim 1, in which a protruding base wall is disposed along the bottom set of crimping teeth for containing a crimped sandwich's contents during the crimping process.

6. A sandwich crimper as claimed in claim 5, in which the base wall features a slope.

7. A sandwich crimper as claimed in claim 1, in which the bottom set of crimping teeth protrude by 5-15 mm from the lower surface of the crimper base or, when dependent on claim 5 or 6, protrude by 5-15 mm from the base wall.

8. A sandwich crimper as claimed in claim 1, in which the top set of crimping teeth protrude by 5-15 mm from the upper surface of the crimper lid.

9. A sandwich crimper as claimed in claim 1, in which the base of each crimping tooth has a width of 10-30 mm and the opposite, parallel side has a width of 5-20 mm.

10. A sandwich crimper as claimed in claim 1, in which the edges of the crimper base and crimper lid are straight.

11. A sandwich crimper as claimed in claim 1, in which the length of the sandwich crimper is between 10-25 cm and the width of the sandwich crimper is between 10-25 cm.

12. A sandwich crimper as claimed in claim 1, in which the sandwich crimper is square in shape.

13. A sandwich crimper as claimed in claim 1, in which the corners are rounded.

14. A sandwich crimper as claimed in claim 13, in which a lower crimping tooth in the bottom set of crimping teeth is disposed in each rounded corner of the crimper base with a complementary gap in the top set of crimping teeth in the crimper lid.

15. A sandwich crimper as claimed in claim 1 in which the sandwich crimper is circular in shape.

16. A sandwich crimper as claimed in claim 1, in which each crimping tooth is identical in size and shape.

17. A sandwich crimper as claimed in claim 1 in which the top and bottom sets of crimping teeth are complementary in shape in a plurality of orientations.

18. A sandwich crimper as claimed in claim 1 further comprising an aperture disposed in the crimper base for facilitating the removal of a crimped sandwich.

19. A sandwich crimper as claimed in claim 1, in which a second lid is provided for forming a sealed container for storing the crimped sandwich in the crimper base after crimping.

20. A sandwich crimper as claimed in claim 17, in which the second lid is made from silicon.

21. A method of sealing a sandwich comprising the steps:
providing a sandwich crimper as claimed in any proceeding claim;
inserting a first slice of bread into the crimper base, positioned within the retaining wall;
inserting the sandwich contents into the crimper base;
inserting a second slice of bread into the crimper base, aligned with the first slice of bread;
placing the crimper lid over the crimper base; and
applying pressure to the crimper lid, engaging the top and bottom sets of crimping teeth and crimping the edges of the sandwich.

22. A method as claimed in claim 19, in which the first slice of bread and the second slice of bread are sandwich thins.

23. A method as claimed in claim 19, when dependent on claim 5 or 6, in which the filling is retained within the base walls.

24. A method as claimed in claim 19, in which the crimped sandwich is subsequently toasted in a toaster.

25. A method as claimed in claim 19, when dependent on claim 17 or 18, in which the sealing of the sandwich is followed by storing the sandwich by replacing the crimper lid with the second lid.
